(19) United States
(12) Patent Application Publication
(10) Pub. No.: US 2026/0196135 A1
(43) Pub. Date: Jul. 9, 2026

(54) METHOD FOR CONTROLLING A COMMUNICATION DEVICE, COMMUNICATION DEVICE AND VEHICLE HAVING COMMUNICATION DEVICE

(71) Applicant: Continental Automotive Technologies GmbH, Hannover (DE)

(72) Inventors: Ulrich Stählin, Eschborn (DE); Marc Menzel, Weimar (Lahn) (DE); Sebastian Strunck, Niedernhausen (DE); Bettina Erdem, Kronberg (DE)

(73) Assignee: Continental Automotive Technologies GmbH, Hannover (DE)

(21) Appl. No.: 18/862,610

(22) PCT Filed: Apr. 4, 2023
(86) PCT No.: PCT/DE2023/200073

§ 371 Date: Nov. 4, 2024

(30) Foreign Application Priority Data
May 4, 2022 (DE) 10 2022 204 375.8

(51) Int. Cl. G08G 1/00; G08G 1/16; H04W 4/46

(52) U.S. Cl. CPC G08G 1/22; H04W 4/46; G08G 1/163

(57) ABSTRACT

A method for controlling a communication device of a vehicle driving, preferably in an automated or semi-automated manner, in a convoy with at least one further vehicle, wherein the vehicle is configured to transmit and receive a maneuver coordination message and a collective perception message, wherein the maneuver coordination message contains information about planned driving maneuvers for the coordination of driving maneuvers and the collective perception message contains information about the vehicle and environmental information acquired with the environmental sensors of the vehicle checking whether another vehicle transmitting a collective perception message is driving immediately ahead of or following the vehicle, and transmitting the collective perception message dependent on the check of whether at least one other vehicle transmitting a collective perception message is driving ahead of or following the vehicle. The vehicle may comprise the communication device controlled by such a method.

### DESCRIPTION

The invention relates to a method for controlling a communication device of a vehicle driving in an automated manner in a convoy with at least one further vehicle. The invention relates further to a communication device and to a vehicle having such a communication device.

Methods for the communication of vehicles in traffic are known from the prior art. For example, vehicles can provide other road users with information about the vehicle and with information of the environmental sensors of the vehicle via a collective perception message (CPM). The information about the vehicle can be, for example, information concerning the current driving condition (speed, direction of travel, etc.). The information of the environmental sensors can include the information acquired with the environmental sensors as well as further information relating to the sensors, for example the detection range, the resolution or other information which permits a qualitative assessment by the recipient of the information acquired with the environmental sensors.

This information can be used by other road users to react to the other vehicle, for example by adjusting their own manner of driving, or in order to recognize and react to danger points in good time, even if the danger points are still outside the detection range of their own environmental sensors. For example, the vehicles following a lead vehicle can be informed by the collective perception message of the lead vehicle about danger points ahead of the convoy, so that braking or evading maneuvers can be initiated in good time. For example, such collective perception messages can be used within the context of cooperative adaptive cruise control (cooperative-ACC or C-ACC).

Furthermore, vehicles can exchange information for the coordination of driving maneuvers via a so-called maneuver coordination message (MCM). This information can include, for example, information about a planned route, in particular about planned driving maneuvers, so that driving maneuvers can be coordinated, matched to one another and/or carried out jointly. For example, vehicles having a route that is common at least in some sections and/or having a common destination can join together to form a vehicle unit or a convoy. Such a method is generally known by the term “platooning”.

In particular, distances between the vehicles can be reduced by the sharing of information concerning driving maneuvers. Vehicles that are driving ahead can share and/or coordinate information about danger points or maneuvers for the avoidance of accidents, for example evading maneuvers or braking maneuvers, with the following vehicles in good time, so that the following vehicles are able to react more quickly or with a shorter time lag.

Furthermore, information about the convoy can be communicated to other road users via the maneuver coordination messages, for example, in order that the vehicles of the convoy are perceived not as individual vehicles but as a closed convoy. It is thus possible, for example, to prevent another road user from getting in between the vehicles driving in the convoy. Optionally, a vehicle can join the existing convoy via the exchange of maneuver coordination messages.

Communication between the vehicles, in particular within a convoy, in particular the sharing of the maneuver coordination messages and of the collective perception messages, requires a high transmission capacity or a high data rate for transfer of all the required data and information. However, the transmission capacity or the data rate for transmission of the data is frequently limited.

The object of the invention is to provide a method which, even in the case of a limited transmission capacity or a limited data rate for the transmission of information between the vehicles, permits reliable communication within a convoy, which permits safe and reliable driving within the convoy.

In order to achieve the object there is provided a method for controlling the communication of a vehicle driving, in particular in a semi-automated or automated manner, in a convoy with at least one further vehicle, wherein the vehicle is configured to transmit and receive a maneuver coordination message and a collective perception message. The maneuver coordination message contains information for the coordination of driving maneuvers. The collective perception message contains information about the vehicle as well as information of the environmental sensors of the vehicle. The method comprises the following steps:
checking whether another vehicle that transmits a collective perception message is driving immediately ahead of and/or following the vehicle, and
transmitting the collective perception message in dependence on the check of whether at least one other vehicle that transmits a collective perception message is driving ahead of and/or following the vehicle.

The considerations on which the invention is based are that information can be present multiple times within the convoy via the collective perception messages and the maneuver coordination messages. Safe driving within the convoy can also be possible if information is not shared multiple times between the individual vehicles. Furthermore, vehicles driving in a convoy can behave as a joint unit in respect of communication with other vehicles, so that not every vehicle of the convoy has to communicate separately with other road users or provide them with all the information of the convoy via collective perception messages and/or maneuver coordination messages. It is simply necessary for the information of the convoy to be available, for all the vehicles of the convoy and for other road users.

If it is determined that the vehicle is traveling in a convoy with another vehicle, the position of the vehicle within the convoy is checked. Vehicles that are driving immediately one behind the other are here regarded as being a convoy. Vehicles that follow one another directly, that is to say vehicles between which there is no other road user, are regarded as vehicles that are driving “immediately” one behind the other. The vehicles can exchange collective perception messages with one another. For example, the vehicles can also exchange maneuver coordination messages and coordinate their driving maneuvers with one another via the maneuver coordination messages.

In dependence on the position of the vehicle within the convoy, it is thus checked whether the collective perception message and/or the maneuver coordination message must be sent with a full transmission rate or whether this information is optionally already provided by one or more of the other vehicles of the convoy. If that is the case, the transmission rate of the collective perception message and/or of the maneuver coordination message can be reduced in order to reduce the number of messages or the exchanged information within the convoy but also for other road users outside the convoy. In principle, however, at least one vehicle of the convoy always transmits a collective perception message and/or a maneuver coordination message with a transmission rate that is unchanged, that is to say not reduced, so that the information of the convoy is available in its entirety for the vehicles of the convoy and also for other road users. A lower transmission capacity or a lower data rate for the exchange of information between the vehicles of the convoy can thus be sufficient, so that a lower transmission capacity or a lower data rate is required.

For example, it can be assumed that a danger point or an obstacle is first detected by the vehicle that is driving ahead and is communicated to other vehicles via the collective perception message. The following vehicles detect such an obstacle or such a danger point with their own environmental sensors only with a time lag and/or only when the presence of the obstacle or of the danger point has already been communicated to the following and other vehicles by the collective perception message of the vehicle that is driving ahead. It is therefore not necessary for the vehicles that are following the lead vehicle likewise to provide this environmental information to other vehicles with the full transmission rate, since it is to be assumed that most of this information has already been made available to the convoy by the lead vehicle. The transmission rate of the collective perception message can therefore be reduced if there is another vehicle that transmits a maneuver coordination message and a collective perception message ahead of the vehicle.

If the check of the position of the vehicle within the convoy reveals that the vehicle is the lead vehicle of the convoy, the collective perception message is transmitted unchanged. That is to say, the original transmission rate is maintained and the collective perception message is provided unchanged to the other vehicles, in particular to the other vehicles of the convoy, since it is to be assumed that the lead vehicle, as the first vehicle of the convoy, can detect obstacles or danger points and inform the other vehicles thereof via the collective perception message.

Optionally, it can be checked whether the collective perception message of the vehicle contains information, in particular environmental information, which differs from the information contained in the collective perception message of the lead vehicle, for example contains additional environmental information. If the information of the collective perception message of the lead vehicle differs from the information of the vehicle, either the collective perception message can be transmitted with the full transmission rate or only the information that is different is transmitted in the collective perception message.

For example, the vehicles of the convoy may not be traveling as a platoon but may simply be following one another within the context of cooperative adaptive cruise control (cooperative-ACC or C-ACC), so that no maneuver coordination messages or matching maneuver coordination messages are transmitted. In this case, a reduction or adaptation of the maneuver coordination messages is not required.

If the vehicles, within the context of a convoy, additionally coordinate their driving maneuvers via a maneuver coordination message, for example if the convoy forms a platoon, transmission of the maneuver coordination message can also be effected in dependence on the check of whether another vehicle that transmits a maneuver coordination message and a collective perception message is driving ahead of and/or following the vehicle.

Preferably, when it is recognized that at least one other vehicle that transmits a maneuver coordination message and a collective perception message is driving ahead of and/or following the vehicle, the maneuver coordination message of the at least one other vehicle is checked and transmission of the maneuver coordination message is effected in dependence on whether the information about planned driving maneuvers that is contained in the maneuver coordination message matches the planned driving maneuvers of the vehicle at least in part.

It is thus checked whether a vehicle that is driving ahead has the same route and/or the same destination and the driving maneuvers via the maneuver coordination message. If another vehicle that transmits a maneuver coordination message and a collective perception message, in particular a maneuver coordination message with matching information about the destination, the route and/or planned driving maneuvers, is driving ahead of the vehicle, these vehicles can be coupled electronically so that they drive as a joint vehicle unit. In this case, transmission of the own maneuver coordination message can be reduced, since the own maneuver coordination message matches the maneuver coordination message of the vehicle that is driving ahead, and other road users, in particular the following vehicles, already receive the maneuver coordination message of the lead vehicle.

Because the lead vehicle makes the maneuver coordination message available in following vehicles of the convoy with a full transmission rate, it is not necessary for all the following vehicles likewise to transmit the maneuver coordination message with a full transmission rate. In this case, the following vehicles can reduce the transmission of the maneuver coordination message without any loss of information for other road users and the following vehicles, in order to reduce the channel load. In particular, the maneuver coordination message of the lead vehicle can also contain information about the convoy which makes it possible for other road users to identify the vehicles of the convoy and/or to identify the convoy as a jointly driving vehicle unit.

If another vehicle of the convoy is driving ahead of the vehicle and a further vehicle of the convoy is following the vehicle, transmission of the maneuver coordination message can also be suspended completely.

In this embodiment, only the lead vehicle of the convoy and the last vehicle of the convoy transmit maneuver coordination messages. The vehicles driving between the lead vehicle and the last vehicle do not transmit any maneuver coordination message of their own. In particular, these vehicles receive the maneuver coordination message from the lead vehicle, so that it is not necessary for them to supply their own maneuver coordination message to the other vehicles. The last vehicle additionally transmits a maneuver coordination message and thus marks the end of the convoy, wherein the last vehicle can here transmit with a reduced transmission rate. As a result of the transmission of the maneuver coordination messages by the lead vehicle and the last vehicle of the convoy, sufficient identification of the convoy can be made possible for other road users.

The check of whether at least one other vehicle that transmits a maneuver coordination message and a collective perception message is driving ahead of and/or following the vehicle can comprise a distance measurement, wherein the transmission rate of the maneuver coordination message and/or of the collective perception message is reduced only if the distance of the at least one other vehicle that transmits a maneuver coordination message and a collective perception message is at least below a threshold value.

If a threshold value is exceeded, it is assumed that it is expedient for surrounding vehicles to transmit the message with an increased or even the full rate.

The distance measurement can also comprise the measurement of the distance from multiple vehicles of the convoy that are driving ahead, so that brief fluctuations in the distance of the vehicles from one another can be compensated.

In order to achieve the object there is further provided a communication device for a vehicle, for transmitting and receiving a maneuver coordination message and a collective perception message, wherein the maneuver coordination message contains information for the coordination of driving maneuvers and the collective perception message contains information about the vehicle as well as environmental information acquired with the sensors of the vehicle, wherein the transmission of a collective perception message and/or of a maneuver coordination message is effected by at least one of the methods described above.

In order to achieve the object there is further provided a vehicle having a communication device for transmitting and receiving a maneuver coordination message and a collective perception message, wherein the maneuver coordination message contains information for the coordination of driving maneuvers and the collective perception message contains information about the vehicle as well as environmental information acquired with the sensors of the vehicle, wherein the transmission of a collective perception message and/or of a maneuver coordination message is effected by at least one of the methods described above.

Further advantages and features will become apparent from the following description in connection with the appended drawings. In the drawings:

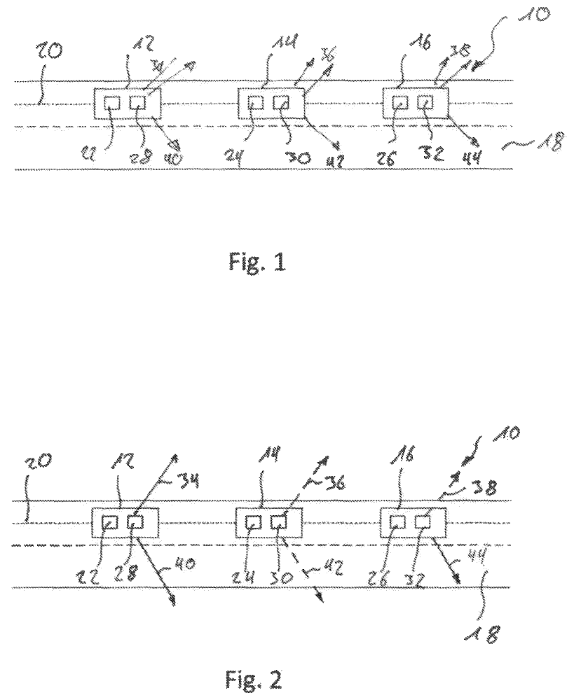

FIG. 1 shows a schematic representation of a convoy in which communication is controlled by a method of the prior art;

FIG. 2 shows a schematic representation of a convoy in which communication is controlled by a method according to the invention; and

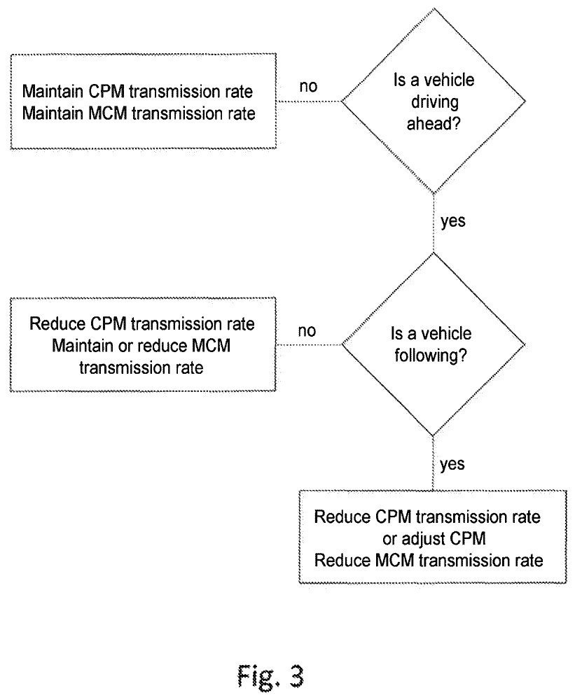

FIG. 3 shows a flowchart for controlling the communication of a vehicle of the convoy of FIG. 2.

FIG. 1 shows a convoy 10 having a plurality of vehicles 12, 14, 16, which are traveling on a road 18. The vehicles are jointly following a common route 20, that is to say have a common destination at least in some sections. Each of the vehicles 12, 14, 16 has a controller 22, 24, 26, which controls various vehicle functions, for example navigation, an autonomous or semi-autonomous vehicle controller or communication with other vehicles. The vehicles each further have a communication device 28, 30, 32 for communication with other vehicles or devices.

Each of the vehicles 12, 14, 16 transmits a collective perception message 34, 36, 38. This collective perception message 34, 36, 38 contains information about the vehicle 12, 14, 16 as well as information of the environmental sensors of the respective vehicle 12, 14, 16. The collective perception message can be received by the communication devices 28, 30, 32 of the other vehicles 12, 14, 16. These can process the information of the other vehicles 12, 14, 16 that is contained in the collective perception message 34, 36, 38 and optionally change the driving behavior of the own vehicle in dependence on that information. If the collective perception message 34, 36, 38 of another vehicle 12, 14, 16 contains, for example, information about danger points or obstacles, the other vehicles 12, 14, 16 are able to react to this information even before the danger point or the obstacle can be detected with their own environmental sensors.

Furthermore, each of the vehicles 12, 14, 16 transmits a maneuver coordination message 40, 42, 44. This maneuver coordination message 40, 42, 44 contains information about the destination, the planned route 20 of the vehicle 12, 14, 16 as well as for the coordination of driving maneuvers of the vehicles 12, 14, 16. If other vehicles 12, 14, 16 receive such a maneuver coordination message 40, 42, 44, they can check, for example, whether the destination and the planned route 20 match their own destination or their own route. If that is the case, the vehicles 12, 14, 16, via the exchange of corresponding information via the maneuver coordination messages 40, 42, 44, can join together to form a convoy 10 and can carry out driving maneuvers in a coordinated manner as a convoy.

If a plurality of vehicles 12, 14, 16 have joined together to form such a convoy 10, driving maneuvers can be coordinated between the vehicles 12, 14, 16 via the maneuver coordination messages 40, 42, 44, so that safe driving within the convoy 10 is possible.

In particular, speed changes, for example braking maneuvers, of a vehicle 12, 14 that is driving ahead can be transmitted to the other vehicles 14, 16 via the maneuver coordination messages 40, 42, so that the following vehicles 14, 16 are able to react to such maneuvers without any loss of time. The safe distance between the vehicles 12, 14, 16, for example, can thus be reduced without losses of safety.

Driving in a convoy 10 in which the vehicles 12, 14, 16 drive independently or have different destinations but communicate with one another via V2X messages is also referred to as cooperative adaptive cruise control (cooperative-ACC or C-ACC).

Driving within a convoy 10 in which the driving maneuvers are coordinated, for example via the maneuver coordination messages 40, 42, 44, is also referred to as platooning. For other road users, the vehicles 12, 14, 16 driving together in such a platoon behave in a similar manner to a train, wherein there is only electronic coupling between the vehicles 12, 14, 16.

The fact that the vehicles 12, 14, 16 are driving in the convoy 10 can also be indicated to other road users via the maneuver coordination message, so that the other road users are able to react thereto. For example, driving maneuvers can be so planned that another road user does not get in between the vehicles 12, 14, 16 of the convoy 10.

Transmission of the collective perception messages 34, 36, 38 and of the maneuver coordination messages 40, 42, 44 requires a relatively high transmission capacity or a high data rate. However, the transmission capacity or the data rate for transmission of the collective perception messages 34, 36, 38 and of the maneuver coordination messages 40, 42, 44 can be limited owing to regulatory requirements or the large number of road users or other transmission devices.

In order to reduce the amount of data transmitted, the collective perception messages 34, 36, 38 and the maneuver coordination messages 40, 42, 44 are transmitted as described below (see FIGS. 2 and 3).

If a vehicle 12, 14, 16 determines that it is driving in a convoy 10 with another vehicle 12, 14, 16, the vehicle 12, 14, 16 checks the position of the vehicle 12, 14, 16 in the convoy 10.

The determination of whether the vehicle 12, 14, 16 is in a convoy 10 is effected via the receiving and checking of the collective perception messages 34, 36, 38 and of the maneuver coordination messages 40, 42, 44 of the other vehicles 12, 14, 16. Via the received collective perception messages 34, 36, 38 and/or the maneuver coordination messages 40, 42, 44, the vehicle 12, 14, 16 can also determine the position of the other vehicles 12, 14, 16.

If one of the other vehicles 12, 14, 16 is located immediately in front of or behind the vehicle 12, 14, 16 and those vehicles share the collective perception messages 34, 36, 38, this is recognized as being a convoy 10. “Immediately in front of or behind” another vehicle 12, 14, 16 here refers to driving directly ahead of or following a vehicle without a further vehicle in between the vehicles 12, 14, 16.

If the check of the position of the vehicle 12, 14, 16 within the convoy 10 reveals that the vehicle 12 is the lead vehicle of this convoy 10, that is to say no further vehicle of the convoy 10 is driving ahead of the vehicle 12, both the collective perception message 34 and the maneuver coordination message 40 of the vehicle 12 are transmitted with an unchanged transmission rate (denoted by the solid arrows 34, 40 in FIG. 2).

If the check of the position of the vehicle 12, 14, 16 within the convoy 10 reveals that at least one other vehicle 12, 14 of the convoy 10 is driving ahead of the vehicle 14, 16, a reduction of the transmission rate of the collective perception messages 36, 38 is effected (denoted by the broken arrows 36, 38).

The consideration on which the reduction of the transmission rate of the collective perception messages 36, 38 is based is that the lead vehicle 12 recognizes obstacles or danger points before the other vehicles 14, 16 of the convoy 10 and can share these with the other vehicles 14, 16, but also with other road users, via the collective perception message 34. Because the following vehicles 14, 16 receive the collective perception message 34 of the lead vehicle 12, the transmission rates of the collective perception messages 36, 38 of the following vehicles 14, 16 can be reduced, since it can be assumed that those collective perception messages contain no or only a small amount of information that goes beyond the information contained in the collective perception message 34 of the lead vehicle 12.

Furthermore, the lead vehicle 12 maintains the transmission rate of the maneuver coordination message 40 (solid arrow 40). The lead vehicle 12 initiates all the coordinated maneuvers of the convoy 10. In order to ensure this, transmission of the maneuver coordination message 40 of the lead vehicle is effected with the full transmission rate, so that all the following vehicles 14, 16 as well as other road users are able to receive the maneuver coordination message without restrictions.

If the check of the position within the convoy 10 of the following vehicles 14, 16 reveals that a further vehicle 16 is following the vehicle 14, the transmission rate of the maneuver coordination message 42 is also reduced. It is assumed that following vehicles 14, 16 receive the maneuver coordination message 40 of the lead vehicle 12, and thus a full transmission capacity of the own maneuver coordination message 42 of the further vehicle is not required.

If the check of the position within the convoy 10 of the following vehicles 14, 16 reveals that no further vehicle is following the vehicle 16, that is to say the vehicle 16 is the last vehicle of the convoy 16, the transmission rate of the maneuver coordination message 44 is maintained unchanged. Other vehicles that receive the maneuver coordination message 44 are thus able to recognize that this vehicle 16 is within a convoy 10.

In summary, only the lead vehicle 12 thus transmits the collective perception message 34 with the full transmission rate, said collective perception message being received by the following vehicles 14, 16. The following vehicles reduce the transmission rate of the collective perception message 34, since the information of the collective perception message 34 of the lead vehicle 12 and the information of the own environmental sensors of the following vehicles can be sufficient for driving within the convoy 10.

Furthermore, the lead vehicle 12 and the last vehicle 16 of the convoy 10 transmit the maneuver coordination messages 40, 44 with the full transmission rate in order to coordinate the convoy 10 and make the convoy 10 recognizable for other road users. Vehicles 14 between the lead vehicle 12 and the last vehicle 16 reduce the transmission rate of the maneuver coordination message 42, since sufficient coordination of the driving maneuvers of the vehicles 12, 14, 16 within the convoy 10 and sufficient identification of the convoy 10 for other road users is possible by means of the maneuver coordination message 40, 44.

Vehicles 14 that have another vehicle 12 ahead of them and another vehicle following them can also check whether the transmission of the collective perception message 36 and/or of the maneuver coordination message 42 can be stopped completely. Furthermore, the last vehicle 16 of the convoy 10 can optionally reduce the transmission rate of the maneuver coordination message 44, since this is not required for coordination of the driving maneuvers with following vehicles.

The position of the vehicles 12, 14, 16 within the convoy 10 is here checked constantly, so that the transmission rate can be adapted in the event of a change of position of the vehicles 12, 14, 16.

If, for example, another road user gets in between the lead vehicle 12 and the following vehicle 14, the lead vehicle 12 might no longer be recognized as the vehicle 12 that is ahead for the vehicle 14. The vehicle 14 would thus be the new lead vehicle of a convoy 10 consisting of the vehicles 14, 16 and would accordingly increase the transmission rate of the collective perception message 36 and of the maneuver coordination message 42.

As soon as the other road user is no longer between the lead vehicle 12 and the following vehicle 14, the vehicle 12 can again be identified as the lead vehicle of the convoy 10, whereupon the transmission rates of the collective perception messages 34, 36, 38 and of the maneuver coordination messages 40, 42, 44 are then adapted again.

In addition, the distance from the vehicle 12, 14, 16 that is driving ahead or following is determined. The transmission rate of the collective perception messages 34, 36, 38 and/or of the maneuver coordination messages 40, 42, 44 is reduced only if the distance from the vehicle 12, 14, 16 that is driving ahead or following is below a defined threshold value. If this threshold value is exceeded, the transmission rate is increased.

The measurement of the distance from vehicles 12, 14, 16 that are driving ahead and/or following can here comprise not only a measurement relative to the vehicle 12, 14, 16 that is driving immediately ahead or following, but measurement of the distance from all the vehicles within the convoy 10. The threshold values with respect to the vehicles 12, 14, 16 that are not driving immediately ahead here correspond, for example, to a multiple of the threshold value of the distance from the vehicle that is driving immediately ahead or following. Slight fluctuations in the distances within the convoy 10 can thus be compensated.

For example, owing to speed changes, it can happen that the threshold value for the distance is exceeded for the vehicle 12, 14, 16 that is driving immediately ahead or following, but the threshold value for the distance is still observed for a vehicle that is driving further ahead or following further behind. If that is the case, driving within a convoy 10 can still be recognized even if a threshold value is exceeded slightly.

1. A method for controlling a communication device of a vehicle driving in a convoy with at least one further vehicle, wherein the vehicle is configured to transmit and receive a maneuver coordination message and a collective perception message wherein the maneuver coordination message contains information for coordination of driving maneuvers and the collective perception message contains information about the vehicle as well as environmental information acquired with environmental sensors of the vehicle comprising:
checking whether another vehicle that transmits a collective perception message is driving immediately ahead of or following the vehicle, and
transmitting the collective perception message dependent on the check of whether at least one other vehicle that transmits a collective perception message is driving ahead of or following the vehicle.

2. The method as claimed in claim 1, wherein transmission rate of the collective perception message is reduced when another vehicle that transmits a collective perception message is driving ahead of the vehicle.

3. The method as claimed in claim 1, wherein transmission of the maneuver coordination message is effected dependent on the check of whether another vehicle that transmits a matching maneuver coordination message is driving ahead of or following the vehicle.

4. The method as claimed in claim 3, wherein, when it is recognized that at least one other vehicle that transmits a maneuver coordination message is driving ahead of or following the vehicle, the maneuver coordination message of the at least one other vehicle is checked and transmission of the maneuver coordination message is effected dependent on whether the information about planned driving maneuvers that is contained in the maneuver coordination message matches the planned driving maneuvers of the vehicle at least in part.

5. The method as claimed in claim 3, wherein transmission rate of the maneuver coordination message is at least reduced when another vehicle that transmits a maneuver coordination message with matching information about planned driving maneuvers is driving ahead of the vehicle.

6. The method as claimed in claim 3, wherein transmission of the maneuver coordination message is suspended when another vehicle that transmits a maneuver coordination message with matching information about planned driving maneuvers is driving ahead of the vehicle and another vehicle that transmits a maneuver coordination message with matching information about planned driving maneuvers is following.

7. The method as claimed in claim 1, wherein the check of whether at least one other vehicle that transmits a collective perception message or a maneuver coordination message with matching information about planned driving maneuvers is driving ahead of or following the vehicle comprises a distance measurement, wherein transmission rate of the collective perception message or of the maneuver coordination message is reduced only when the distance of the at least one other vehicle that transmits a collective perception message or a maneuver coordination message with matching information about planned driving maneuvers is at least below a threshold value.

8. A communication device for a vehicle for transmitting and receiving a collective perception message and a maneuver coordination message wherein the collective perception message contains information about the vehicle as well as environmental information acquired with the environmental sensors of the vehicle and wherein the maneuver coordination message contains information for the coordination of driving maneuvers, wherein transmission of the collective perception message or of the maneuver coordination message is effected by a method as claimed in claim 1.

9. A vehicle having a communication device for transmitting and receiving a collective perception message and a maneuver coordination message, wherein the collective perception message contains information about the vehicle as well as environmental information acquired with the environmental sensors of the vehicle, and wherein the maneuver coordination message contains information for the coordination of driving maneuvers, wherein transmission of the collective perception message or of the maneuver coordination message is effected by a method as claimed in claim 1.

10. The method for controlling a communication device of a vehicle as claimed in claim 1 wherein the vehicle is driving in an automated or semi-automated manner.

11. The method as claimed in claim 2, wherein transmission of the maneuver coordination message is effected dependent on the check of whether another vehicle that transmits a matching maneuver coordination message is driving ahead of or following the vehicle.

12. The method as claimed in claim 11, wherein, when it is recognized that at least one other vehicle that transmits a maneuver coordination message is driving ahead of or following the vehicle, the maneuver coordination message of the at least one other vehicle is checked and transmission of the maneuver coordination message is effected dependent on whether the information about planned driving maneuvers that is contained in the maneuver coordination message matches the planned driving maneuvers of the vehicle at least in part.

13. The method as claimed in claim 11, wherein the transmission rate of the maneuver coordination message is at least reduced when another vehicle that transmits a maneuver coordination message with matching information about planned driving maneuvers is driving ahead of the vehicle.

14. The method as claimed in claim 11, wherein transmission of the maneuver coordination message is suspended when another vehicle that transmits a maneuver coordination message with matching information about planned driving maneuvers is driving ahead of the vehicle, and another vehicle that transmits a maneuver coordination message with matching information about planned driving maneuvers is following.

15. The method as claimed in claim 11, wherein the check of whether at least one other vehicle that transmits a collective perception message or a maneuver coordination message with matching information about planned driving maneuvers is driving ahead of or following the vehicle comprises a distance measurement, wherein the transmission rate of the collective perception message or of the maneuver coordination message is reduced only when the distance of the at least one other vehicle that transmits a collective perception message or a maneuver coordination message with matching information about planned driving maneuvers is at least below a threshold value.

16. The method as claimed in claim 12, wherein the transmission rate of the maneuver coordination message is at least reduced when another vehicle that transmits a maneuver coordination message with matching information about planned driving maneuvers is driving ahead of the vehicle.

17. The method as claimed in claim 12, wherein transmission of the maneuver coordination message is suspended when another vehicle that transmits a maneuver coordination message with matching information about planned driving maneuvers is driving ahead of the vehicle, and another vehicle that transmits a maneuver coordination message with matching information about planned driving maneuvers is following.

18. The method as claimed in claim 12, wherein the check of whether at least one other vehicle that transmits a collective perception message or a maneuver coordination message with matching information about planned driving maneuvers is driving ahead of or following the vehicle comprises a distance measurement, wherein the transmission rate of the collective perception message or of the maneuver coordination message is reduced only when the distance of the at least one other vehicle that transmits a collective perception message or a maneuver coordination message with matching information about planned driving maneuvers is at least below a threshold value.

19. A communication device for a vehicle for transmitting and receiving a collective perception message and a maneuver coordination message, wherein the collective perception message contains information about the vehicle as well as environmental information acquired with the environmental sensors of the vehicle, and wherein the maneuver coordination message contains information for the coordination of driving maneuvers, wherein the transmission of the collective perception message or of the maneuver coordination message is effected by a method as claimed in claim 2.

20. A communication device for a vehicle for transmitting and receiving a collective perception message and a maneuver coordination message, wherein the collective perception message contains information about the vehicle as well as environmental information acquired with the environmental sensors of the vehicle, and wherein the maneuver coordination message contains information for the coordination of driving maneuvers, wherein the transmission of the collective perception message or of the maneuver coordination message is effected by a method as claimed in claim 3.
